(19) United States
(12) Patent Application Publication
(10) Pub. No.: US 2024/0059849 A1
(43) Pub. Date: Feb. 22, 2024

(54) PLASTIC RESIN COMPOSITE COMPRISING SILANE, AND PREPARATION METHOD THEREFOR

(71) Applicants: LG ELECTRONICS INC., Seoul (KR); KOREA ADVANCED INSTITUTE OF SCIENCE AND TECHNOLOGY, Deajeon (KR)

(72) Inventors: Taegyu JIN, Seoul (KR); Sanghyun HONG, Seoul (KR); Seongsu KIM, Daejeon (KR); Wonvin KIM, Daejeon (KR); Jae-Moon JEONG, Daejeon (KR); Sangyoon BAE, Daejeon (KR)

(21) Appl. No.: 18/278,900

(22) PCT Filed: Jan. 21, 2022
(86) PCT No.: PCT/KR2022/001126

§ 371 Date: Aug. 25, 2023

(30) Foreign Application Priority Data
Feb. 26, 2021 (KR) 10-2021-0026558

(51) Int. Cl. C08J 5/04; C08J 5/06; C08K 5/5415; C08K 7/20

(52) U.S. Cl. CPC C08J 5/046; C08J 5/043; C08J 5/06; C08K 5/5415; C08K 7/20; C08J 2355/02; C08J 2369/00

(57) ABSTRACT

The present invention relates to a plastic resin composite comprising silane, and a preparation method therefor. A plastic resin composite comprising silane, according to the present invention, comprises fiber, a fiber composite comprising silane formed on the surface of the fiber, and a plastic resin bound to the fiber composite, and thus is lightweight and has excellent mechanical strength.

### TECHNICAL FIELD

The present disclosure relates to a plastic resin composite comprising silane and a preparation method therefor, in which the formation of a gel caused by self-condensation of silanol is prevented, and fiber is dispersed smoothly, ensuring a plastic resin composite exhibiting lightweightness and high strength, and a preparation method therefor.

### BACKGROUND ART

A composite is a material in which materials of different components and physical properties are artificially mixed or bonded to maximize the properties of each of the materials or allow each of the material to exhibit new properties that would not otherwise be shown in a single material.

A composite exhibits physical properties such as strength, corrosion resistance, fatigue life, wear resistance, impact resistance, lightweightness and the like that are more excellent than those of existing materials, and is hailed as a 21th-century industrial material in a variety of fields ranging from an aerospace industry, a sporting goods industry, a vessel industry, a construction industry, a vehicle industry to an energy industry.

A composite has a structure that is usually comprised of a reinforced material tolerating/in charge of a load applied to a material, and a matrix being bonded to the reinforced material and delivering the load to the reinforced material. The reinforced material usually comprises a variety of fiber-type reinforced materials such as glass fiber, carbon fiber, aramid fiber and the like, and the matrix usually comprises a resin-type matrix such as a thermosetting resin comprising phenol, epoxy and the like, or a thermoplastic resin comprising polyvinyl chloride (PVC), polyethylene, polypropylene, polyamide, polyacetal, polybutyleneterephthalate, polyphenylenesulphide and the like.

Such a fiber reinforced plastic is a complex material in which a synthetic resin and a fiber reinforced material are combined, such that advantages such as the tensile strength, the impact resistance, the thermal resistance and the like of plastics are additionally ensured with the help of a fiber reinforced material added, while advantages such as the corrosion resistance and the ease of molding of plastics are maintained.

A fiber reinforced plastic is cheap and lightweight, and used in various ways for a variety of home appliances, the hull of a small-sized vessel, a bath tub, a septic tank and the like and tends to be applied to an increasing number of technical fields.

In relation to this, KR Patent Publication No. 10-2018-0031783 (published on Mar. 28, 2018) relates to a polyolefine composition comprising a hollow glass microsphere. In the document, a composition comprising polyolefine, a hollow glass microsphere, a semi-crystalline polar thermoplastic additive and an impact modifier or a compatibilizer is disclosed.

Additionally, WO Patent Publication No. WO2015/146718 (published on Oct. 1, 2015) relates to a polyarylene sulfide-based resin composition and an insert mold object. In the document, the PAS-based resin composition comprises a polyarylene sulfide resin having a carboxyl terminus, an olefin-based copolymer, glass fiber and calcium carbonate, and the surface of the glass fiber is treated with a silane coupling agent.

Further, US Patent Publication No. 2008/0011194 (published on Jan. 17, 2008) relates to a wood fiber synthetic resin composite. In the document, the wood fiber synthetic resin composite comprises a cellulose material, a silane containing polymer, a thermoplastic resin and a mixture of a lubricant comprising a metallic stearate or a reaction product, and the silane containing polymer is prepared based on the copolymerization of ethylene-type unsaturated silane and alpha olefin.

In the above documents, a silane coupling agent is used to enhance an inner facial bolding force between fiber and a resin based on a chemical bond to the fiber and a strong bond to the resin. However, a gel is formed due to the self-condensation of silanol, and the fiber is hardly dispersed (see FIG. 1).

### DESCRIPTION OF INVENTION

### Technical Problems

The objective of the present disclosure is to provide a plastic resin composite comprising silane that ensures lightweightness and excellent strength, since a lightweight fiber is used as a strength reinforced material, and the fiber is treated with silane to offset deterioration in strength caused by the addition of the reinforced material.

The objective of the present disclosure is to provide a preparation method for a plastic resin composite comprising silane that maintains the strength of the plastic composite and ensures lightweightness, since the self-condensation of silanol is prevented.

Aspects according to the present disclosure are not limited to the above ones, and other aspects and advantages that are not mentioned above can be clearly understood from the following description and can be more clearly understood from the embodiments set forth herein. Additionally, understandably, the aspects and advantages in the present disclosure are embodied via means and combinations thereof that are described in the appended claims.

### Technical Solutions

According to the present disclosure, provided is a plastic resin composite comprising silane, which comprises a fiber composite comprising fiber as a reinforced material and silane that is uniformly formed on the fiber since the formation of a gel, caused by self-condensation of silanol, does not occur on the fiber, and a plastic resin as a matrix for preparing lightweight plastics.

Specifically, unlike a conventional method, a method for preparing a plastic resin composite comprising silane according to the present disclosure involves forming silane on fiber uniformly while silanol is not formed on the fiber, such that the uniformly formed silane helps to improve a bonding force with a plastic resin, thereby ensuring improvement in strength and lightweightness.

At this time, the fiber may be one or more sorts selected from a group consisting of a lyocell fiber, a glass fiber and an aramid fiber.

With respect to a total weight of the fiber composite, 0.5-5.0 wt % of silane may be included.

The plastic resin may comprise one or more sorts that are selected from a group consisting of acrylonitrile butadiene styrene (ABS), polycarbonate (PC) and polypropylene (PP).

With respect to a total volume of the plastic resin composite, 15-35 volume % of the fiber composite may be included.

According to the present disclosure, provided is a preparation method for a plastic resin composite comprising silane comprises adding a silane compound to a mixture solution comprising distilled water, methanol and a weak acid, submerging fiber into the mixture solution to which the silane compound is added and then thermally treating the fiber, and mixing the fiber where silane is formed with a plastic resin.

At this time, a 3-5 volume ratio of methanol may be included with respect to volume of the distilled water.

The weak acid may be an acetic acid (CH3COOH) or a carbonic acid (H2CO3), and included to adjust the pH of the mixture solution within a range of 4-5.

The silane compound has an alkoxy group, and specifically, comprises one or more sorts selected from 3-(methacryloxypropyl)trimethoxysilane, tetramethoxysilane, tetraethoxysilane, tetrapropoxysilane, tetraisopropoxysilane, tetra-n-butoxysilane, tetra-sec-butoxy silane, tetra-tert-butoxysilane, trimethoxysilane, triethoxysilane, methyltrimethoxysilane, methyltriethoxysilane, ethyltrimethoxysilane, ethyltriethoxysilane, propyltrimethoxysilane, propyltriethoxysilane, isobutyltriethoxysilane, cyclohexyltrimethoxysilane, phenyltrimethoxysilane, phenyltriethoxysilane, vinyltrimethoxysilane, vinyltriethoxysilane, allyltrimethoxysilane, allyltriethoxysilane, dimethylmethoxysilane, dimethylethoxysilane, diphenyldimethoxysilane and diphenyldiethoxysilane.

With respect to a total weight of the mixture solution, 0.5-5.0 wt % of the silane compound may be included.

The thermal treatment may be performed at 90-130° C., for 2-8 minutes.

The preparation method for a plastic resin composite comprising silane according to the present disclosure may further comprise mixing the fiber where silane is formed with the plastic resin and then adding glass bubbles, and the fiber where silane is formed, the plastic resin and the glass bubbles may be included respectively at 5-15 wt %, 60-80 wt % and 15-25 wt %.

### Advantageous Effects

In a method of the present disclosure different from a conventional method, silane may be formed uniformly on fiber while silanol is not formed on the fiber, and the uniformly formed silane helps to improve a coupling force with the plastic resin, ensuring strength and making it possible to prepare a lightweight plastic resin composite.

Additionally, the plastic resin composite comprising silane in the present disclosure may be applied to a variety of materials for a plastic component that needs to be lightweight, leading to a reduction in power consumption resulting from a reduction of the weight of the component at a time of operating the component.

Further, the plastic resin composite comprising silane in the present disclosure may help to reduce a load applied to the body of the user such a wrist of the user, in the case where the user directly carries a product such as a vacuum cleaner of an upper center of mass, a drone, a dryer and the like.

Specific effects are described along with the above-described effects in the section of detailed description.

### BRIEF DESCRIPTION OF DRAWINGS

FIG. 1 is a schematic view showing the formation of a gel caused by self-condensation of silanol, on fiber that is manufactured in a conventional method.

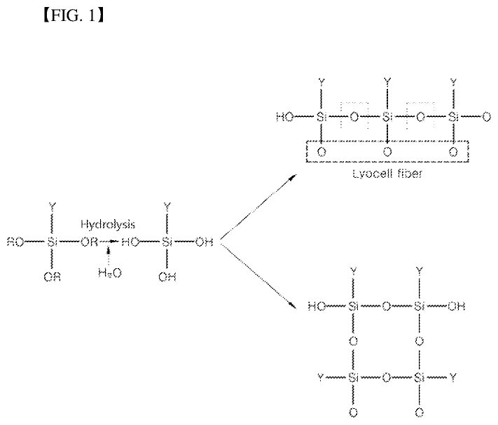

FIG. 2 is a schematic view showing a preparation method for a plastic resin composite comprising silane in the present disclosure.

FIG. 3a is a photo of a scanning electron microscope (SEM), showing a lyocell fiber that is not treated with silane.

FIG. 3b shows results of an energy-dispersive X-ray spectroscopy (EDS) of a lyocell fiber that is not treated with silane.

FIG. 4a is a photo of a scanning electron microscope (SEM), showing a lyocell fiber that is treated with silane.

FIG. 4b shows results of an energy-dispersive X-ray spectroscopy (EDS) of a lyocell fiber that is treated with silane.

FIG. 5 is a graph showing the tensile strength of a plastic resin composite comprising silane in the present disclosure.

### DETAILED DESCRIPTION OF EXEMPLARY EMBODIMENTS

The above-described aspects, features and advantages are specifically described hereafter with reference to the accompanying drawings such that one having ordinary skill in the art to which the present disclosure pertains can embody the technical idea of the disclosure easily. In the disclosure, detailed description of known technologies in relation to the disclosure is omitted if it is deemed to make the gist of the disclosure unnecessarily vague. Hereafter, preferred embodiments according to the disclosure are specifically described with reference to the accompanying drawings. In the drawings, identical reference numerals can denote identical or similar components.

The terms “first”, “second” and the like are used herein only to distinguish one component from another component. Thus, the components are not to be limited by the terms. Certainly, a first component can be a second component, unless stated to the contrary.

Throughout the disclosure, each component can be provided a single one or a plurality of ones, unless stated to the contrary.

In the disclosure, the singular forms “a”, “an” and “the” are intended to include the plural forms as well, unless explicitly indicated otherwise. In the disclosure, the terms “comprise” or “include” and the like, set forth herein, are not interpreted as necessarily including all the stated components or steps but can be interpreted as excluding some of the stated components or steps or can be interpreted as including additional components or steps.

Hereafter, a plastic resin composite and a preparation method therefor according to the present disclosure are described.

In the present disclosure, provided is a plastic resin composite comprising silane, comprising: a fiber composite that comprises fiber, and silane formed on the surface of the fiber; and
a plastic resin that is bonded to the fiber composite.

Conventionally, a variety of additives such as a glass bubble may be used to reduce the weight of plastics. At this time, strength usually deteriorates.

To improve strength, fiber may be used as a reinforced material. However, in the case where fiber is solely used, the effect of reinforcing strength is not produced. To improve strength, silane is formed on the surface of fiber.

However, in the case where the silane formed on the surface of the fiber is bonded with water and experiences hydrolysis, methanol is formed as an alkoxy group included in the silane comes off, and a gel is formed based on the self-condensation of silanol, making it difficult to disperse the fiber and ensure improvement in strength.

To solve the above problem, in the present disclosure, since methanol is added at a high concentration in a mixture solution in which a silane compound dissolves, silanol is not self-condensed, and a gel is not formed.

Accordingly, in a method of the present disclosure different from a conventional method, silane may be formed uniformly on fiber while silanol is not formed on the fiber, and the uniformly formed silane helps to improve a coupling force with the plastic resin, ensuring strength and making it possible to prepare a lightweight plastic resin composite.

Additionally, the plastic resin composite comprising silane in the present disclosure may be applied to a variety of materials for a plastic component that needs to be lightweight, leading to a reduction in power consumption resulting from a reduction of the weight of the component at a time of operating the component.

Further, the plastic resin composite comprising silane in the present disclosure may help to reduce a load applied to the body of the user such a wrist of the user, in the case where the user directly carries a product such as a vacuum cleaner of an upper center of mass, a drone, a dryer and the like.

At this time, the fiber may be a natural fiber or an artificial fiber, and in the case where the fiber is a natural fiber, the fiber is fiber referred to as lyocell and extracted from the nature, and is hailed as an advanced fiber material that is silky smooth, naturally colored, durable, pleasantly wearable, luxurious and practical in a variety of fields.

The pulp of a eucalyptus tree is used as a raw material for a lyocell fiber used in the present disclosure and is soft and is usually used for children's clothing, underwear and bedding, and is manufactured more environmentally friendly than rayon and buried in the ground and biologically degraded after one month.

Additionally, the manufacturing of a lyocell fiber is flexible, and a lyocell fiber is highly crystalline, long crystalline and a highly crystalline directional, is highly directional in a non-crystalline area and the like, and ensures high dry and wet tensile strengths, high wet strength and high loop tenacity.

In the case where the fiber is an artificial fiber, a glass fiber or an aramid fiber and the like may be used as the fiber. However, it is preferable to use a lyocell fiber as a natural fiber, considering its coupling force with the plastic resin and biological degradation.

For the fiber composite, silane is formed on the surface of the fiber to improve a coupling force with the plastic resin, and a 0.5-5.0 wt % of silane may be preferably included in the total weight of the fiber composite. In the case where less than 0.5 wt % of silane is included, the strength of the plastic rein composite does not improve, and in the case where more than 5.0 wt % of silane is included, an excessive amount of silane is formed on the surface of the fiber, and a lump of silane is formed, degrading a coupling with the plastic resin.

The plastic resin may comprise one or more sorts selected from a group consisting of acrylonitrile butadiene styrene, polyalkylene carbonate and polyurethane.

Among the above described plastic resins, acrylonitrile butadiene styrene is a thermoplastic resin that compensates the disadvantages of polystyrene and the shortcomings of a AS resin or high impact polystyrene, and ensures excellent transmittance, processability, electrical properties of polystyrene, has the mechanical strength, heat resistance, oil resistance and climate resistance and the like of polystyrene and ensures ease of processing, impact resistance and heat resistance, to replace metal of interior and exterior materials for a vehicle as well as a home appliance.

The fiber composite is preferably included at volume of 15-35 volume %, with respect to the entire volume of the plastic resin composite. In the case where less than 15 volume % of the fiber composite is included, strength does not improve sufficiently, and in the case where greater than 35 wt % of the fiber composite is included, low dispersity of the fiber is highly likely to cause a defect in the plastic resin composite.

For the plastic resin composite comprising silane in the present disclosure, since silanol is not formed on fiber, silane is uniformly formed on the fiber, and an interfacial bonding force of the . . . with the plastic resin improves, such that the mechanical strength of the plastic resin composite improves.

Further, in the present disclosure, provided is a preparation method for a plastic resin composite comprising saline. The preparation method comprises adding a silane compound to a mixture solution comprising distilled water, methanol and a weak acid;
submerging fiber into the mixture solution to which the silane compound is added and then thermally treating the fiber; and
mixing the fiber where silane is formed with a plastic resin.

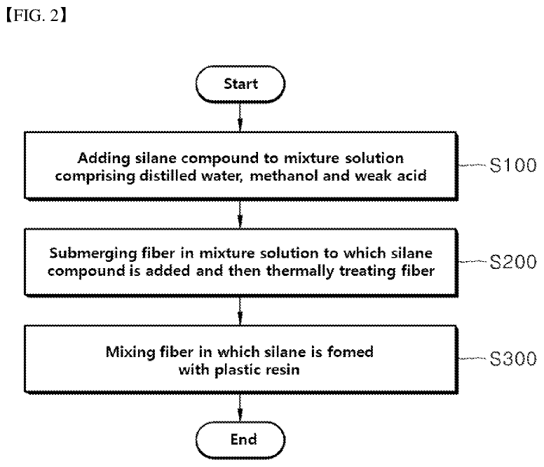

FIG. 2 is a flowchart showing a preparation method for a plastic resin composite comprising silane in the present disclosure.

The subject matter of the present disclosure is specifically described with reference o FIG. 2.

The preparation method for a plastic resin composite comprising silane in the present disclosure comprises adding a silane compound to a mixture solution comprising distilled water, methanol and a weak acid (S100).

At this time, a 3-5 volume ratio of methanol is preferably included with respect to the volume of distilled water. In the case where less than a 3 volume ratio of methanol is included, silane makes a lump excessively. In the case where greater than a 5 volume ratio of methanol is included, sinale is not properly formed on the fiber.

The weak acid may be acetic acid (CH3COOH) or carbonic acid (H2CO3), and the weak acid is included to adjust the pH of the mixture solution to a range of 4-5. In the case where the pH of the mixture solution is outside the above range, hydrolysis is not be performed properly, and the stabilization of silanol deteriorates.

Then the preparation method for a plastic resin composite comprising silane in the present disclosure comprises submerging fiber into the mixture solution to which the silane compound is added and then thermally treating the fiber (S200).

Since silane is formed on the surface of the fiber, an adhesive force between the fiber and the plastic resin may improve.

At this time, the silane compound may comprise one or more sorts selected from a group consisting of 3-(methacryloxypropyl)trimethoxysilane, tetramethoxysilane, tetraethoxysilane, tetrapropoxysilane, tetraisopropoxysilane, tetra-n-butoxysilane, tetra-sec-butoxy silane, tetra-tert-butoxysilane, trimethoxysilane, triethoxysilane, methyltrimethoxysilane, methyltriethoxysilane, ethyltrimethoxysilane, ethyltriethoxysilane, propyltrimethoxysilane, propyltriethoxysilane, is obutyltriethoxy silane, cyclohexyltrimethoxysilane, phenyltrimethoxysilane, phenyltriethoxysilane, vinyltrimethoxysilane, vinyltriethoxysilane, allyltrimethoxysilane, allyltriethoxysilane, dimethylmethoxysilane, dimethylethoxysilane, diphenyldimethoxysilane and diphenyldiethoxysilane.

Additionally, 0.5-5.0 wt % of the silane compound is preferably included with respect to the total weight of the mixture solution. The silane compound is restricted for the above-described reasons.

Further, the thermal treatment is preferably performed at 90-130° C. for 2-8 minutes. In the case where the thermal treatment is performed outside the above range, the silane compound is not formed on the fiber.

The preparation method for a resin composite in the present disclosure comprises mixing the fiber where silane is formed with a plastic resin (S300).

The fiber has an improved interfacial bonding force with the plastic resin with the help of silane on the fiber, such that the strength of the plastic resin composite improves.

Further, 15-35 volume % of a fiber composite is preferably included with respect to the entire volume of the plastic resin composite. In the case where less than 15 volume % of the fiber composite is included, strength does not improve sufficiently, and in the case where greater than 35 wt % of the fiber composite is included, the fiber composite is included excessively compared to the plastic resin, the physical properties of a final plastic product deteriorate.

Further, the preparation method for a resin composite comprising silane in the present disclosure may further comprise mixing the fiber where silane is formed with the plastic resin and then adding glass bubbles.

The fiber where silane is formed, the plastic resin and the glass bubbles are included respectively at 5-15 wt %, 60-80 wt % and 15-25 wt %, preferably. In the case where less than 15 wt % of the glass bubbles is included, the tensile strength of the plastic resin does not improve, and in the case where greater than 25 wt % of the glass bubbles is included, a portion of the . . . , where an interfacial bonding force between the glass bubbles and the resin deteriorates, increases, the tensile strength of the . . . deteriorates, and a reduction in the fiber content results in deterioration of the improvement in the tensile strength of the . . . .

Hereafter, the subject matter of the present disclosure is described specifically with reference to the embodiments. The embodiments are provided only as examples, to described the subject matter of the disclosure specifically. The subject matter of the disclosure is limited by the embodiments.

### EMBODIMENTS

### Embodiment 1: Preparation of Plastic Resin Composite 1

1. Preparation of Mixture Solution of Silane Compound

Distilled water, methanol and an acetic acid were mixed to prepare an acetic acid mixture solution, and then 1 wt % of 3-(methacryloxypropyl)trimethoxysilane was added, and the mixture solution was stirred until the mixture solution became transparent, to prepare a mixture solution of a silane compound.

2. Preparation of Fiber in which Silane is Formed

A lyocell fiber was submerged in the mixture solution of the silane compound for two hours, to infiltrate the mixture solution of the silane compound into the cell wall of the lyocell fiber. After the lyocell fiber was taken out of the mixture solution, the lyocell fiber was heated at 110° C. for five minutes, to bond silane to the lyocell fiber, and the mixture solution of the silane compound, remaining on the fiber, was removed with methanol, and the fiber was dried.

3. Preparation of Plastic Resin Composite

Further, 15 volume % of the prepared lyocell fiber (a fiber composite) in which silane was formed was added to acrylonitrile butadiene styrene (ABS) to prepare a plastic resin composite.

### Embodiment 2: Preparation of Plastic Resin Composite 2

The plastic resin composite was prepared in the same way as that of embodiment 1 except that 0.5 wt % of 3-(methacryloxypropyl)trimethoxysilane was added.

### Embodiment 3: Preparation of Plastic Resin Composite 3

The Plastic Resin Composite was Prepared in the Same Way as that of Embodiment 1 except that 5.0 wt % of 3-(methacryloxypropyl)trimethoxysilane was added.

### Embodiment 4: Preparation of Plastic Resin Composite 4

The plastic resin composite was prepared in the same way as that of embodiment 1 except that 22 volume % of a lyocell fiber in which silane was formed in embodiment 1 was added to acrylonitrile butadiene styrene (ABS) to prepare a plastic resin composite.

### Embodiment 5: Preparation of Plastic Resin Composite 5

The plastic resin composite was prepared in the same way as that of embodiment 1 except that 0.5 wt % of 3-(methacryloxypropyl)trimethoxysilane was added in embodiment 4.

### Embodiment 6: Preparation of Plastic Resin Composite 6

The plastic resin composite was prepared in the same way as that of embodiment 1 except that 5.0 wt % of 3-(methacryloxypropyl)trimethoxysilane was added in embodiment 4.

### Embodiment 7: Preparation of Plastic Resin Composite 7

The plastic resin composite was prepared in the same way as that of embodiment 1 except that 35 volume % of a lyocell fiber in which silane was formed in embodiment 1 was added to acrylonitrile butadiene styrene (ABS) to prepare a plastic resin composite.

### Embodiment 8: Preparation of Plastic Resin Composite 8

The plastic resin composite was prepared in the same way as that of embodiment 1 except that 0.5 wt % of 3-(methacryloxypropyl)trimethoxysilane was added in embodiment 7.

### Embodiment 9: Preparation of Plastic Resin Composite 9

The plastic resin composite was prepared in the same way as that of embodiment 1 except that 5.0 wt % of 3-(methacryloxypropyl)trimethoxysilane was added in embodiment 7.

### Embodiment 10: Preparation of Plastic Resin Composite 10

To prepare a plastic resin composite, 5-15 wt % of the lyocell fiber which was prepared in embodiment 1 and in which silane was formed, 15-25 wt % of glass bubbles, and 60-80 wt % of acrylonitrile butadiene styrene (ABS) were mixed.

### Comparative Example 1

Acrylonitrile butadiene styrene having a diameter of 2 mm was used.

### Comparative Example 2

Acrylonitrile butadiene styrene having a diameter of 3 mm was used.

### Comparative Example 3

A lyocell fiber in which a zinc oxide nano rod was not formed, and acrylonitrile butadiene styrene were mixed at a volume % of 78:22 to prepare a complex resin.

Table 1 hereafter shows components of embodiments 1 to 10, and comparative examples 1 to 3, in detail.

TABLE 1

| | | Lyocell fiber | | | | |
|---|---|---|---|---|---|---|
| | | Non- | Silane | Silane | Glass | Total |
| Example | ABS | treated | content | formation | bubbles | volume % |
| Embodiment 1 | 85 | — | 1.0 | 15 | — | 100 |
| | volume % | | wt % | volume % | | |
| Embodiment 2 | 85 | — | 0.5 | 15 | — | 100 |
| | volume % | | wt % | volume % | | |
| Embodiment 3 | 85 | — | 5.0 | 15 | — | 100 |
| | volume % | | wt % | volume % | | |
| Embodiment 4 | 78 | — | 1.0 | 22 | — | 100 |
| | volume % | | wt % | volume % | | |
| Embodiment 5 | 78 | — | 0.5 | 22 | — | 100 |
| | volume % | | wt % | volume % | | |
| Embodiment 6 | 78 | — | 5.0 | 22 | — | 100 |
| | volume % | | wt % | volume % | | |
| Embodiment 7 | 65 | — | 1.0 | 35 | — | 100 |
| | volume % | | wt % | volume % | | |
| Embodiment 8 | 65 | — | 0.5 | 35 | — | 100 |
| | volume % | | wt % | volume % | | |
| Embodiment 9 | 65 | — | 5.0 | 35 | — | 100 |
| | volume % | | wt % | volume % | | |
| Embodiment 10 | 60~80 | — | 1.0 | 5-15 | 15-25 | — |
| | wt % | | wt % | wt % | wt % | |
| Comparative | 10 | — | | — | — | 100 |
| example 1 | volume % | | | | | |
| Comparative | 100 | — | | — | — | 100 |
| example 2 | volume % | | | | | |
| Comparative | 78 | 22 | | — | — | 100 |
| example 3 | volume % | volume % | | | | |

### Experimental Examples

Experimental example 1: Analysis of fiber composite before and after treatment with silane solution

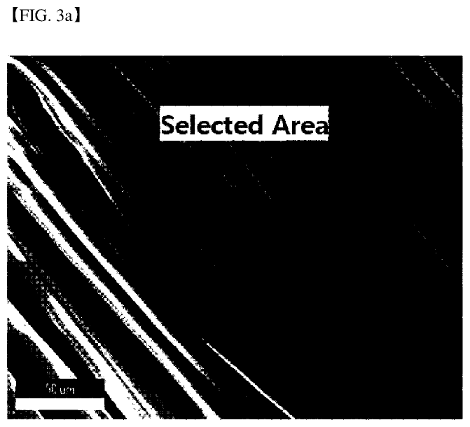

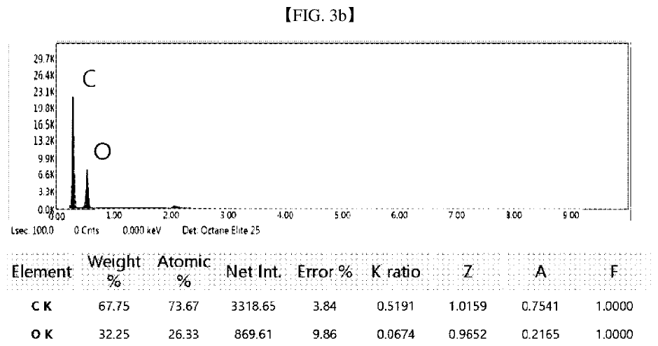

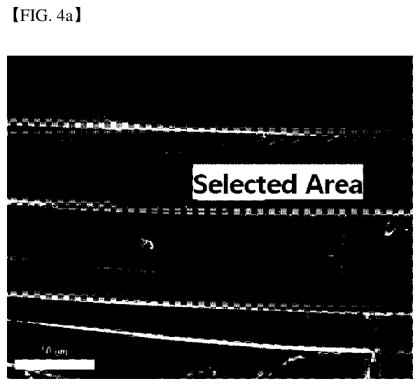

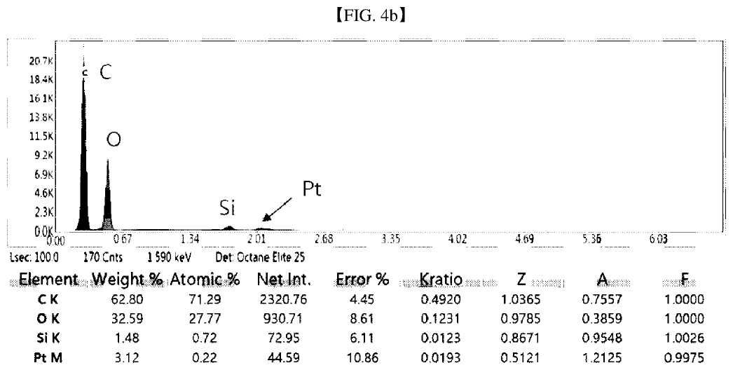

In the plastic resin composite comprising silane according to the present disclosure, the fiber composite before and after treatment with a silane solution was analyzed with an SEM and an EDS. Results of the analysis are shown in FIGS. 3a, 3b, 4a and 4b.

FIG. 3a is an SEM photo of a lyocell fiber that does not comprise silane, and FIG. 3b shows results of an EDS analysis of the lyocell fiber. As shown in FIGS. 3a and 3b, the lyocell fiber is only detected.

FIG. 4a is an SEM photo of a lyocell fiber that comprises silane, and FIG. 4b shows results of an EDS analysis of the lyocell fiber. FIG. 4a and FIG. 4b show that the lyocell fiber comprises an Si element after treatment with silane and that treatment of the surface of the lyocell fiber with silane is properly performed.

Additionally, FIG. 4a and FIG. 4b show that a gel is not formed after treatment with silane such that the lyocell fiber is easily dispersed.

### Experimental Example 2: Analysis of Tensile Strength of Plastic Resin Composite

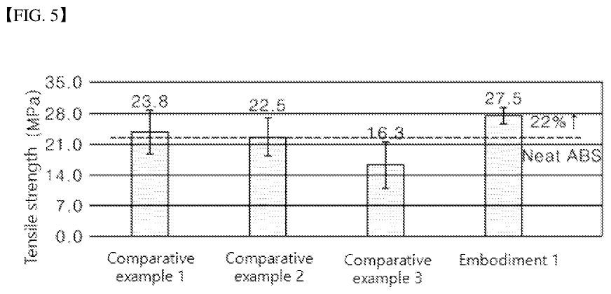

The tensile strength of the plastic resin composite comprising silane according to the present disclosure, and the tensile strength of the resin prepared in comparative examples 1 to 4 were analyzed. Results of the analysis are shown in FIG. 5.

To measure tensile strength, samples were pulled at a cross head speed of 200 mm/min(1T), with a test device (a UTM of Instron and of model number 4466), based on the ASTM D638 method, and then a point at which the sample was cut was measured. Tensile strength was calculated as follows.

Tensile strength (kgf/mm²)=Load (load) value (kgf)/thickness (mm)×width (m).

As shown in FIG. 5, the tensile strength of a pure lyocell fiber was respectively 23.8 MPa and 22.5 MPa, and the tensile strength of the resin composite of comparative example 3, to which the lyocell was added, was 16.3 MPa that was less than the tensile strength of the pure lyocell fiber.

However, the tensile strength of the complex resin of embodiment 1, to which a lyocell fiber treated with silane was added, was 27.5 MPa that was greater than the tensile strength of the pure lyocell fiber by 22%.

Thus, for the plastic resin composite according to the present disclosure, silane is uniformly formed on fiber, and the interfacial bonding force of the . . . with the plastic resin improves, such that the strength of the plastic resin composite improves.

The embodiments are described above with reference to a number of illustrative embodiments thereof. However, embodiments are not limited to the embodiments and drawings set forth herein, and numerous other modifications and embodiments can be drawn by one skilled in the art within the technical scope of the disclosure. Further, the effects and predictable effects based on the configurations in the disclosure are to be included within the range of the disclosure though not explicitly described in the description of the embodiment.

1. A plastic resin composite comprising:
a fiber composite including fiber, and silane that is provided on a surface of the fiber; and
a plastic resin bonded to the fiber composite.

2. The plastic resin composite of claim 1, wherein the fiber includes one or more of lyocell fiber, glass fiber, or aramid fiber.

3. The plastic resin composite of claim 1, wherein the plastic resin composite includes 0.5-5.0 wt % of the silane with respect to a total weight of the fiber composite.

4. The plastic resin composite of claim 1, wherein the plastic resin comprises includes one or more of acrylonitrile butadiene styrene (ABS), polycarbonate (PC), polyalkylene carbonate, or polypropylene (PP).

5. The plastic resin composite of claim 1, wherein the plastic resin composite includes 15-35 volume % of the fiber composite with respect to a total volume of the plastic resin composite.

6. The plastic resin composite of claim 1, wherein the plastic resin composite is formed through a preparation method that includes:
adding a silane compound to a mixture solution including distilled water, methanol, and a weak acid;
submerging the fiber into the mixture solution to which the silane compound is added and then thermally treating the fiber to form the fiber composite; and
mixing the fiber composite where the plastic resin.

7. The plastic resin composite of claim 6, wherein the mixture solution includes volume ratio of methanol with respect to distilled water.

8. The preparation method plastic resin composite of claim 6, wherein the weak acid includes at least one of an acetic acid (CH₃COOH) or a carbonic acid (H₂CO₃).

9. The plastic resin composite of claim 6, wherein the weak acid adjusts a pH of the mixture solution within a range of 4-5.

10. The plastic resin composite of claim 1, wherein the silane includes one or more sorts of 3-(methacryloxypropyl) trimethoxysilane, tetramethoxysilane, tetraethoxysilane, tetrapropoxysilane, tetraisopropoxysilane, tetra-n-butoxysilane, tetra-sec-butoxysilane, tetra-tert-butoxysilane, trimethoxysilane, triethoxysilane, methyltrimethoxysilane, methyltriethoxysilane, ethyltrimethoxysilane, ethyltriethoxysilane, propyltrimethoxysilane, propyltriethoxysilane, isobutyltriethoxysilane, cyclohexyltrimethoxysilane, phenyltrimethoxysilane, phenyltriethoxysilane, vinyltrimethoxysilane, vinyltriethoxysilane, allyltrimethoxysilane, allyltriethoxysilane, dimethylmethoxysilane, dimethylethoxysilane, diphenyldimethoxysilane, or diphenyldiethoxysilane.

11. The plastic resin composite of claim 6, wherein the thermal treatment of the fiber is performed at 90-130° C., for 2-8 minutes.

12. The plastic resin composite of claim 6, wherein the silane compound includes 0.5-5 wt % of the silane with respect to a total weight of the mixture solution.

13. The plastic resin composite of claim 6, wherein the preparation method further includes adding glass bubbles to the fiber composite mixed with the plastic resin.

14. The plastic resin composite of claim 13, wherein the fiber composite, the plastic resin and the glass bubbles are included respectively at 5-15 wt %, 60-80 wt % and 15-25 wt %.

15. The plastic resin composite of claim 1, wherein the plastic resin composite has a tensile strength of greater than 23.8 MPa, as measured based on American Society for Testing and Materials (ASTM) D638 method.
